(19) United States
(12) Patent Application Publication
(10) Pub. No.: US 2021/0021913 A1
(43) Pub. Date: Jan. 21, 2021

(54) UNDERWATER DATA CAPTURE AND TRANSMISSION SYSTEM

(71) Applicant: Continental Shelf Associates, Inc., Stuart, FL (US)

(72) Inventor: Kevin Clyde Peterson, Stuart, FL (US)

(73) Assignee: Continental Shelf Associates, Inc., Stuart, FL (US)

(21) Appl. No.: 16/929,292

(22) Filed: Jul. 15, 2020

Related U.S. Application Data
(60) Provisional application No. 62/875,026, filed on Jul. 17, 2019.

(51) Int. Cl. H04Q 9/00; H04B 13/02

(52) U.S. Cl. CPC H04Q 9/00; G16Y 20/10; H04B 13/02

(57) ABSTRACT

An underwater data capture and transmission system has a base configured to sink in water, a sensor configured to capture data while submerged in water, a data buoy sized and configured to be at least partially disposed within a housing, a processing unit configured to selectively release the data buoy from the housing to allow the data buoy to travel toward a surface of the water, and a tether for coupling the housing and sensor to the base. The sensor is configured to capture data while submerged underwater and transmit the data to the data buoy by the processing unit. The data buoy is configured to transmit the data to a recipient after being released from the housing and floating to the surface.

### CROSS-REFERENCE TO RELATED APPLICATIONS

This application claims priority to U.S. Provisional Patent Application No. 62/875,026, filed on Jul. 17, 2019, which is herein incorporated by reference in its entirety.

### TECHNICAL FIELD

This application relates generally to data capture and transmission, and, more particularly, to an underwater data capture and transmission system.

### BACKGROUND

Underwater data acquisition systems can be deployed from vessels of opportunity to collect remote underwater sensor data. Such systems do not require permanent infrastructure for deployment or operation. However, the cost and effort associated with collecting deep water data from the sensors of such systems can be expensive and problematic. The present disclosure is directed to overcoming these and other problems of the prior art.

### SUMMARY

In an embodiment, the present disclosure is directed to an underwater data capture and transmission system. The system includes a base configured to sink in water, a sensor configured to capture data while submerged in water, a data buoy sized and configured to be at least partially disposed within a housing and configured to receive data collected by the sensor, a processing unit configured to selectively release the data buoy from the housing to allow the data buoy to travel toward a surface of the water, and a tether for coupling the housing and sensor to the base.

In other embodiments, the present disclosure is directed to a data buoy. The data buoy includes a controller configured to execute software instructions, a data storage in signal communication with the controller, the data storage configured to store data collected from one or more sensors, a communication module comprising a transceiver and an antenna, the communication module in signal communication with the controller and configured to transmit data to a remote location, a power module for providing power to the controller and the communication module, a float constructed of a buoyant material, and a coupler configured to engage a housing. The float is configured to cause the data buoy to move toward a water surface when the coupler is disengaged from the housing.

### BRIEF DESCRIPTION OF THE DRAWINGS

Various exemplary embodiments are described in detail below with reference to the following Figures. The drawings are provided for purposes of illustration only and merely depict exemplary embodiments. These drawings are provided to facilitate the reader's understanding of the embodiments and should not be considered limiting of the breadth, scope, or applicability of the disclosure. It should be noted that for clarity and ease of illustration these drawings are not necessarily drawn to scale.

FIG. 1 is a diagram of an exemplary underwater data capture and transmission system, in accordance with various embodiments;

FIG. 2 is a block diagram of an exemplary processing unity for the underwater data capture and transmission system of FIG. 1, in accordance with various embodiments;

FIG. 3 is a block diagram of an exemplary releasable data buoy, in accordance with various embodiments; and

FIG. 4 is a flowchart of an exemplary data capture and transmission process, in accordance with various embodiments.

### DETAILED DESCRIPTION

This description of embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively or operably connected” is such an attachment, coupling or connection that allows the pertinent structures to operate as intended by virtue of that relationship.

The data acquisition systems described herein may include one or more releasable data buoys (RDB) that are configured to relay acquired subsea data to a surface client. In various embodiments, the system may include multiple RDBs configured to couple to a single primary processing unit (PPU) allowing for multiple sensor data sets to be recovered over long-term deployments of the system. Subsea data may be collected, stored and then transmitted (e.g., utilizing Iridium satellite or other suitable transmission technology) to any shore base or mobile asset equipped with a transceiver (e.g., an Iridium transceiver). Because data may be transmitted at multiple times during the deployment of the system, this intermittent data may be used to validate operations and augment modeling efforts. In addition, near real-time events can be captured with event notification to clients on a global scale.

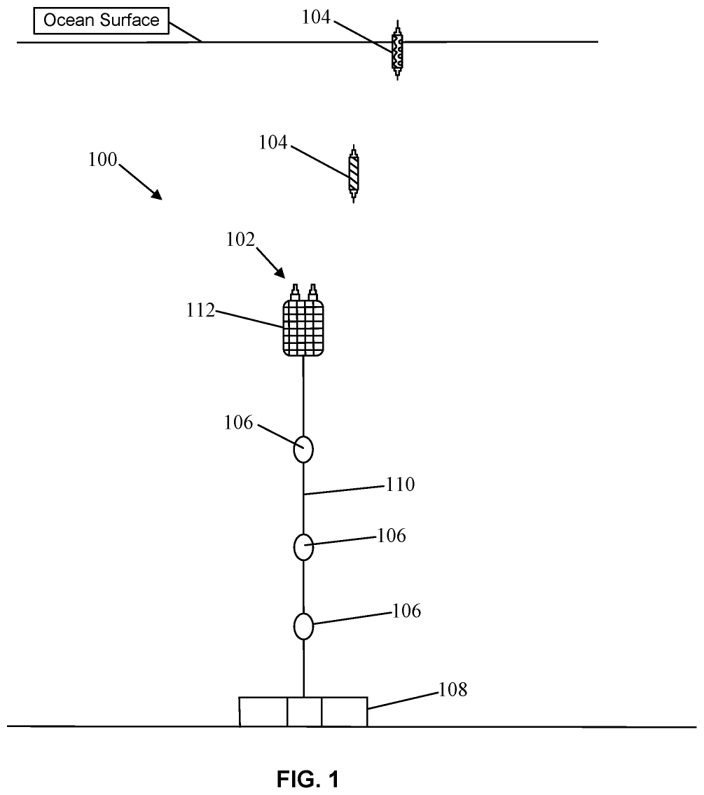

FIG. 1 is a diagram of an exemplary data capture and transmission system 100 in accordance with some embodiments. System 100 may include a primary processing unit (PPU) 102, a releasable data buoy (RDB) 104, a sensor 106, a base 108, and a tether 110. One of ordinary skill in the art will understand that system 100 may include plural PPUs 102, RBDs 104, sensors 106, bases 108, and tethers 110. The RDBs 104 are configured to be at least partially (or entirely) disposed in a housing 112. For example, when system 100 is deployed, RBDs 104 may be at least partially disposed in housing 102. In some embodiments, the PPU 102 and the housing 112 are collocated, e.g., the PPU 102 is disposed within the housing 112, or adjacent, e.g., the PPU 102 is disposed within its own, separate housing (not shown) disposed adjacent to housing 112. In other embodiments, the PPU 102 is disposed within its own, separate housing (not shown) and spaced apart from housing 112.

The housing 112 may include a plurality of RDBs 104 and be configured to release an RDB 104 to allow the RDB 104 to float to the ocean surface. FIG. 1 illustrates a first RDB 104A floating toward the ocean surface and a second RDB 104B at the ocean surface. The RDBs 104 may be released automatically or on command. For example, an RDB 104 may be released after a set amount of time or data has been collected, or a release mechanism may allow remote control by a user to release an RDB.

The system 100 may include any appropriate type of sensors and may include multiple sensors of the same type as well as combinations of different types of sensors. For example, the system 100 may include oceanographic sensors—such as conductivity sensors, temperature sensors, pressure sensors, depth sensors, turbidity sensors, dissolved oxygen sensors, current sensors, water level sensors, tsunami sensors, optics and various other analog and digital instruments. The system 100 may also include sensors for gathering acoustic data—such as sensors configured for passive acoustic monitoring, detection of mammals, detection of vessel traffic, and/or surveillance. The system 100 may also include sensors configured for subsea communications monitoring—such as sensors configured to provide a cable status indication, node monitoring, and/or security.

The plurality of sensors 106 may be configured for underwater data collection. The plurality of sensors 106 may be spaced from each other along the tether 110 to collect data at different locations (e.g., different ocean depths). The sensors 106 may be configured to generate a signal indicative of a monitored parameter (e.g., pressure, flow rate, presence or absence of a material or compound, to list only a few non-exclusive examples). In some embodiments, one or more of the sensors 106 may be image capture devices configured to capture image data. The sensors 106 may be configured to transmit data to the RDBs 104.

The base 108 may include a weighted component configured to anchor the sensors 106 and the tether 110 to locations under the water. The base 108 may be configured as a stationary component configured to maintain the PPU 102 and sensors 106 in a general area under the water. In some embodiments, the base 108 may be configured for remote control to move the base 108 to another location on the ocean floor. For example, the base may include wheels and/or ballast system to assist in moving the base 108 from one location to another on the ocean floor.

The base 108 may be configured such that it can release the tether 110 to allow the PPU 102, sensors 106, and/or housing 112 to float to the surface where they can be recovered. For example, in one embodiment, the base 108 is configured to release the tether 110 based on an acoustic signal. In such embodiments, the base 108 may include an acoustic release or burn wire. For example, an acoustic signal may be sent from a vessel to the system 100 to trigger release of the tether 110. In response to receipt of the acoustic signal, the base 108 releases the tether 110, thereby allowing the PPU 102, sensors 106, and/or housing to float toward surface while leaving the base 108 on the sea floor. Upon release, or upon surfacing, the PPU 102 may transmit a datagram containing information regarding its geographic position to allow it to be tracked and located. For example, the PPU 102 may transmit Iridium Short Burst Data (SBD) transmissions.

The tether 110 may be fabricated from a strong and durable material to form a reliable connection between the base 108, sensors 106, PPU 102, and housing 112. The tether 110, in some embodiments, may be and/or include data transmission capability between the sensors 106 and the PPU 102. For example, the tether 110 may include a data transmission wire to enable the sensors 106 to transmit data to the PPU 102 and the RDBs 104.

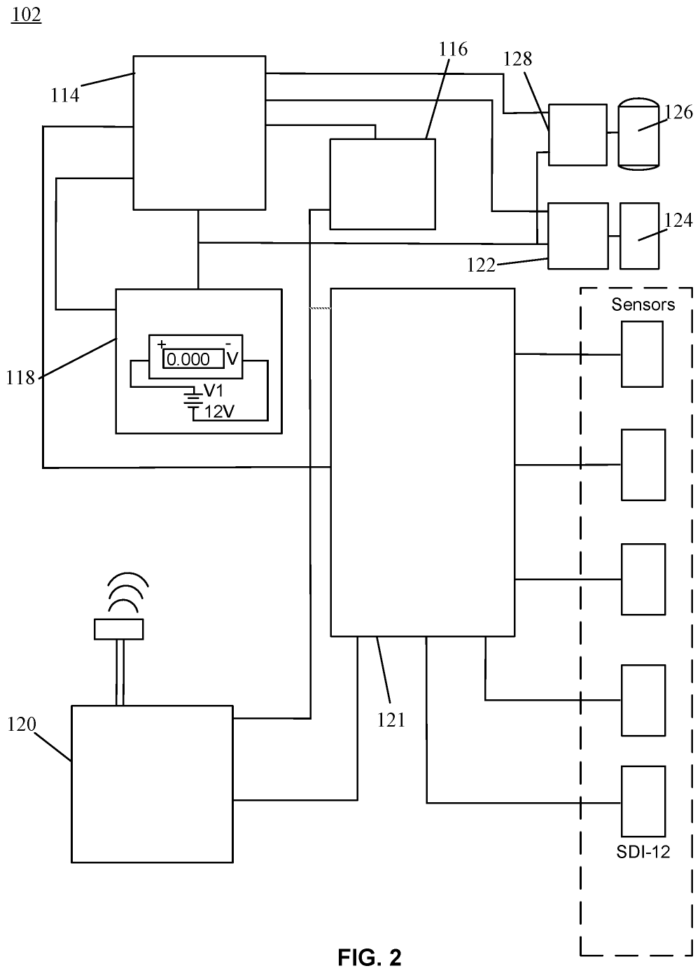

FIG. 2 is a block diagram of an exemplary embodiment of the PPU 102 in accordance with some embodiments. As illustrated in FIG. 2, the PPU 102 may include an embedded controller 114, a master data storage module 116, and a battery or other power supply 118. The PPU 102 may also include a transmission module 120, which may include an Iridium antenna. The PPU 102 may include a communication module 121 for communication with the sensors 106 allowing for command and control of the sensors 106 and data transfer from the sensors 106 to the PPU 102 (e.g., to the controller 114 and data storage module 116 of the PPU 102). The controller 114 may be, for example, a microcontroller (e.g., a single board computer), although one of ordinary skill in the art will understand that the controller may include a plurality of microcontrollers or other suitable control electronics. The data storage module 116 may be any appropriate memory device, such as, for example, a solid state hard drive.

The PPU 102 may also include a release mechanism 122 configured to selectively retain and release the RDBs 104 disposed in the housing 112 and coupled to an RDB docking station 124. In embodiments in which the PPU 102 and the housing 112 are collocated or adjacent, the release mechanism 122 may be a mechanical release mechanism. In other embodiments, in which the PPU 102 and the housing 112 are spaced apart, the PPU 102 may be mechanically or electrically coupled to a release mechanism within, or coupled to, the housing 112 to release the RDBs 104 from the RDB docking station 124. The PPU 102 may further include a receiver 126 to receive signals and an A/D converter 128 to convert analog signals to digital data. In exemplary embodiments, the receiver 126 is configured to receive acoustic signals for controlling the release mechanism 122. For example, such an acoustic signal may be sent from a vessel of opportunity to trigger release of an RDB 104. The release mechanism 122 may include a mechanical latch that is electrically actuated to retain and release the RDBs 104 by moving a sliding pin or a rotating mechanical stop that secures the RDBs in place. One or more of the RDBs 104 be held in place with an electromagnetic latch that releases upon command or automatically in the event of power failure in a “fail safe” mode

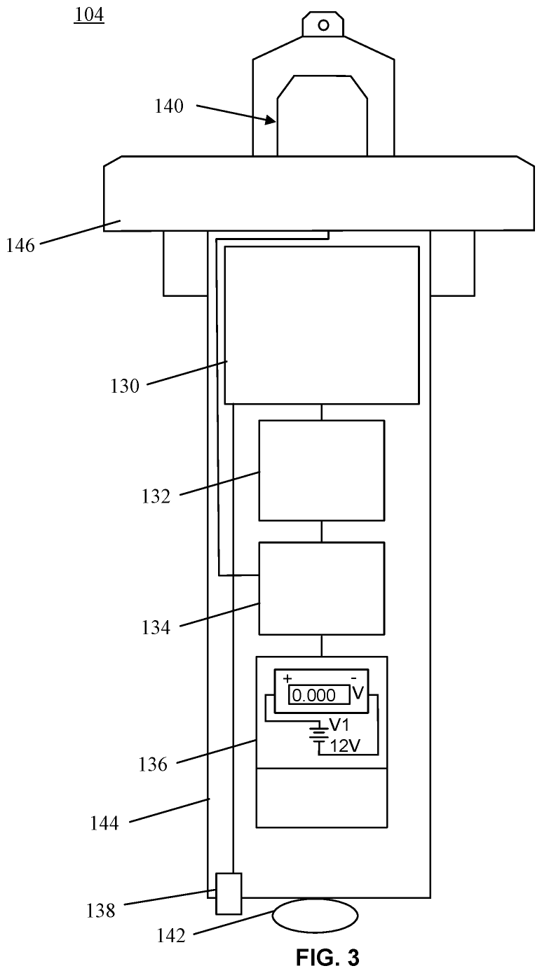

FIG. 3 is a block diagram of an exemplary RDB 104. In an exemplary embodiment, the RDB 104 includes a controller 130, a data storage module 132 (e.g., a solid state hard drive), a transceiver 134 (e.g., an Iridium transceiver), a power module 136, a connector 138, an antenna 140 (e.g., an Iridium antenna), and a coupler 142 configured to engage the release mechanism 122 of the PPU 102 or the RDB docking station 124. One or more of these components may be disposed in a housing 144. The housing 144 may be configured to withstand the pressure caused by being submerged underwater to depths of several hundred or thousands of feet. The connector 138 is configured to electronically couple the controller 130 of the RDB 104 to the controller 114 of the PPU 102, such that signals and/or power may be supplied to the RDB 104. This allows data from the sensors 106 (e.g., raw or processed data) to be loaded into the data storage module 132 of the RDB 104. In addition, the power supply 118 of the PPU 102 may maintain a full charge in the power module 136 of the RDB 104. In some embodiments, the connector 138 is an inductive coupler. The transceiver 134 and antenna 140 are configured to transmit the data, as described further herein, and may be, for example, Iridium-based transceivers and antennas. The connector 138 and/or other connections within the system 100 may utilize a direct connection method of fiber optic to fiber optic connection, and/or electrical conductor to electrical conductor connection through an underwater connector arrangement, or it may utilize inductive connectivity to transmit signal and power through an inductive coupler, similar in nature to those used in wireless cell phone charging stations or other industrial applications.

The coupler 142 of the RDB 104 and the release mechanism 122 of the PPU 102 are configured such that each of the RDBs 104 can be selectively released to allow the RDB 104 to float to the surface of the water (e.g., ocean, lake, or other water body) to allow the RDB 104 to transmit data to a satellite or other recipient. In various embodiments, the RDB 104 includes a float 146 constructed of a buoyant material (e.g., syntactic foam) to facilitate the RDB 104′s progression to the surface.

As described above, each RDB 104 may be positively buoyant, creating an upward buoyancy force on the RDB 104. In some embodiments, the release mechanism 122 of the PPU 102 may include a mechanical attachment point engaged with the coupler 142 to hold the RDB 104 in place. In such embodiments, upon activation of a release command the PPU 102 will activate a mechanical actuator to physically open the release mechanism 122 that is holding the RDB 104 in place to release the RDB 104. In other embodiments, the release mechanism 122 of the PPU 102 may include a magnetic attachment point engaged with the coupler 142 to hold the RDB 104 in place. In such embodiments, upon activation of a release command, the PPU 102 may release the magnetic coupling by moving the magnets apart or depowering an electromagnetic force.

In at least one embodiment, one of the sensors 106 is a (water) current meter. In use, for example, a data set containing six months of current meter data may be used to verify operation of the system 100 and provide preliminary results. In such embodiments, the PPU 102 may be programmed to collect current meter data from the current sensor, store the data (in the data storage module 116 of the PPU 102), and forward it to one of the RDBs 104 for storage in the data storage module 132 of the RDB 104. After the RDB 104 is powered on and data is transferred to the RDB 104, the RDB 104 is released by the release mechanism 122 and the RDB 104 floats to the surface. With the RDB 104 at or near the surface, the antenna 140 and transceiver 134 establishes a connection with a recipient (e.g., via an Iridium antenna) and data is transferred to the recipient.

Further, in various embodiments, one of the sensors 106 is an acoustic sensor configured to acquire an acoustic signature of interest. Based on the acoustic signature, the distance and bearing of the source of the acoustic signature is calculated (e.g., by the controller 114 of the PPU 102). This data may then be transferred or copied to an RDB 104 and the RDB 104 may be released by the release mechanism 122 to allow the RDB 104 to float to the surface. The data may then be transferred to a recipient via the transceiver 134 and antenna 140.

In some embodiments, the PPU 102 is configured to release RDBs 104 at predetermined intervals. Alternatively, or additionally, the PPU 102 may be configured to release RDBs 104 upon the occurrence of certain events. For example, if data generated by the sensors crosses a predetermined threshold, the PPU 102 may release an RDB 104 so that such data may be transmitted to a recipient. In addition, time and event based occurrences can be programmed, for example, through a graphical user interface (GUI) to control the timing of the release of the RDBs 104.

Alternatively, or additionally, the PPU 102 may be configured to release RDBs 104 in response to the receipt of a release signal. For example, once on site, a vessel may lower a transducer and send a release command to the subsea PPU 102. In response to receipt of the signal (e.g., by the acoustic receiver 126), the PPU 102 releases the appropriate RDB 104, thereby allowing it to float to the ocean surface. Once it is at or near the surface, the RDB 104 transmits the data (e.g., via satellite communications). The release mechanism 122 may take different forms for different applications. For example, in some embodiments (e.g., applications in which an automatic release is desired in the event of a power loss), a magnetic release may be used. In other embodiments, a mechanical latch that is operated by an electromechanical actuator may be used. In some applications, the RDB 104 may only be released at times determined by the PPU 102, for example.

In various embodiments, the RDB 104 transmits the data to a satellite for further transmission to desired recipients. Alternatively, or additionally, data can be transmitted directly to a vessel of opportunity or other recipient. In some embodiments, the RDB 104 may also be configured to transmit the position (e.g., GPS coordinates) of the RDB 104 to allow for recovery of the RDB 104. In other embodiments, the RDB 104 may be configured to be a single use device.

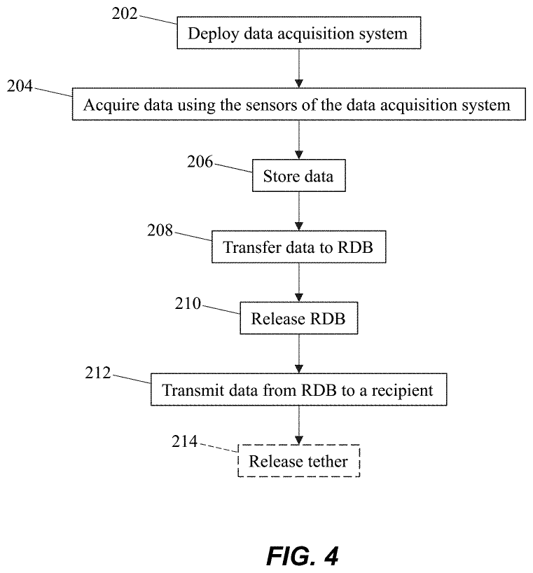

FIG. 4 is a flowchart of an exemplary process 200 of acquiring and transmitting underwater data in accordance with some embodiments. One or more components of the system 100 may perform the steps of process 200. In some embodiments, the process 200 may include computer-implemented steps, such as one or more steps carried out by hardware executing software instructions stored in an associated computer-readable medium.

At 202, the system 100 is deployed. For example, the base 108 may be released into a water body (e.g., ocean, lake, river, man-made body, etc.) and sink to the floor or to a designated depth. The base 108 may thereby pull the PPU 102, RDBs 104, sensors 106, and tether 110 underwater.

At 204, the sensors 106 may collect data while underwater. For example, the sensors 106 may detect signals indicative of one or more parameters. In some embodiments, the sensors 106 may collect image data.

At 206, the PPU 102 may receive and store the collected sensor data. For example, the PPU 102 may store the collected data in the data storage module 116 of the PPU 102.

At 208, the PPU 102 may transfer the received data to an RDB 104. For example, the controller 114 may execute stored software instructions to initiate a data transfer from the PPU 102 to the RDB 104. The data storage module 132 of the RDB 104 may be configured to receive the transferred data. The PPU 102 may select an RDB 104 to receive the data. For example, some RDBs 104 may be particularly configured for certain data transmission and the controller 114 may select such an RDB 104 for data receipt. In other embodiments, the PPU 102 may select a next RDB 104 in a sequence. In still other embodiments, the PPU 102 may transmit the data to a plurality of (e.g., all of) the RDBs 104.

At 210, the PPU 102 may release the RDB 104 from the housing 112 to allow the RDB 104 to float or otherwise travel to the surface. For example, the PPU 102 may transmit a signal to the release mechanism 122 (e.g., an electromechanical latch) to cause release of the RDB 104 from the housing 112. The controller 114 may transmit an electronic signal to the controller 130 with instructions to actuate or otherwise disconnect the coupler 142 to cause the RDB 104 to be released from the housing 112. The RDB 104 may thereafter float or travel toward the surface of the water.

At 212, the released RDB 104 may transmit data from the RDB 104 to a recipient. For example, the RDB 104 that has floated to the surface may include the controller 130 causing the transceiver 134 and/or antenna 140 to establish a remote connection with a recipient to enable wireless transmission of the data collected by the sensor(s) 106 and transferred to the RDB 104.

In some embodiments, the method may further include, at 214, releasing the tether 110 of the system 100 to allow the PPU 102 and sensors 106 to float or otherwise travel to the surface (e.g., for subsequent tracking and collection).

While the foregoing description and drawings represent preferred or exemplary embodiments, it will be understood that various additions, modifications and substitutions may be made therein without departing from the spirit and scope and range of equivalents. In particular, it will be clear to those skilled in the art that the disclosed systems and methods may be embodied in other forms, structures, arrangements, proportions, sizes, and with other elements, materials, and components, without departing from the spirit or essential characteristics thereof. In addition, numerous variations in the methods/processes described herein may be made without departing from the spirit of the disclosure. One of ordinary skill in the art will further appreciate that the disclosed systems and methods may be used with many modifications of structure, arrangement, proportions, sizes, materials, and components and otherwise, used in the practice of the invention, which are particularly adapted to specific environments and operative requirements without departing from the principles of the disclosure. The presently disclosed embodiments are therefore to be considered in all respects as illustrative and not restrictive.

What is claimed is:

1. A system, comprising:
a base configured to sink in water;
a sensor configured to capture data while submerged in water;
a data buoy sized and configured to be at least partially disposed within a housing and configured to receive data collected by the sensor;
a processing unit configured to selectively release the data buoy from the housing to allow the data buoy to travel toward a surface of the water; and
a tether for coupling the housing and sensor to the base.

2. The system of claim 1, wherein the processing unit comprises a data storage device configured to store the data collected by the sensor.

3. The system of claim 2, wherein the processing unit further comprises a controller configured to transmit the data collected by the sensor from the data storage device to the data buoy.

4. The system of claim 1, further comprising a release mechanism coupled between the housing and the data buoy, and wherein the processing unit comprises a controller configured to actuate the release mechanism to release the data buoy from the housing.

5. The system of claim 4, wherein the release mechanism comprises a mechanical release.

6. The system of claim 4, wherein the release mechanism comprises a magnetic release.

7. The system of claim 1, wherein the processing unit comprises a controller and a receiver configured to receive signals comprising instructions for the controller.

8. The system of claim 7, wherein the receiver is an acoustic receiver configured to receive acoustic signals while submerged in water.

9. The system of claim 1, wherein the base is configured to selectively release a connection to the tether.

10. The system of claim 1, wherein the sensor is configured to transmit data to the processing unit via the tether.

11. The system of claim 1, wherein the processing unit and the data buoy each comprises a power source.

12. The system of claim 10, wherein the power source of the processing unit is configured to maintain a charge of the power source of the data buoy prior to the release of the data buoy.

13. The system of claim 1, wherein data buoy comprises a controller, a data storage module, a transceiver, and an antenna, and wherein the data buoy is configured to receive data collected by the one or more sensors and transmit the data to a recipient by the transceiver and antenna.

14. The system of claim 13, wherein the data buoy comprises a float constructed of a buoyant material.

15. The system of claim 1, further comprising a plurality of data buoys at least partially disposed in the housing.

16. A data buoy, comprising:
a controller configured to execute software instructions;
a data storage in signal communication with the controller, the data storage configured to store data collected from one or more sensors;
a communication module comprising a transceiver and an antenna, the communication module in signal communication with the controller and configured to transmit data to a remote location;
a power module for providing power to the controller and the communication module; and
a float constructed of a buoyant material; and
a coupler configured to engage a housing,
wherein the float is configured to cause the data buoy to move toward a water surface when the coupler is disengaged from the housing.

17. The data buoy of claim 16, wherein the transceiver is an iridium transceiver and the antenna is an iridium antenna.

18. The data buoy of claim 16, wherein the float is a syntactic float.

19. The data buoy of claim 16, wherein the coupler is a mechanical coupler.

20. The data buoy of claim 16, wherein the coupler is a magnetic coupler.
